(19) United States
(12) Patent Application Publication
(10) Pub. No.: US 2014/0180764 A1
(43) Pub. Date: Jun. 26, 2014

(54) SHARED RIDE FEEDBACK

(71) Applicant: Jens Lehmann, Sunnyvale, CA (US)

(72) Inventor: Jens Lehmann, Sunnyvale, CA (US)

(73) Assignee: SAP AG, Walldorf (DE)

(21) Appl. No.: 13/722,488

(22) Filed: Dec. 20, 2012

(51) Int. Cl. G06Q 30/02

(52) U.S. Cl. CPC G06Q 30/0203
USPC 705/7.32

(57) ABSTRACT

A message may be sent to a user to solicit user feedback about a shared ride parameter. The message may include a question based on a value of the parameter. A response to the message may be received from the user. A setting of a ride sharing system may be modified based on the response. The modified setting may be a shared ride parameter value associated with the user. The message may be sent as an e-mail, a text message, a web page, and/or a chat message. The message may be automatically generated based on data collected by a computer of a vehicle used for the shared ride.

### BACKGROUND

While driving has many benefits, driving has some drawbacks as well. For example, driving can be expensive because of fuel costs, car maintenance, insurance, etc. With the number of vehicles on the road increasing, traffic has also become a significant problem especially in metropolitan areas. Further, vehicles typically emit CO₂, and many localities have enacted CO₂ emissions reduction strategies with a focus on car emissions. Thus, it would be beneficial to reduce the number of vehicles on the road.

“Carpooling” can reduce the number of vehicles on the road. Carpooling is where two or more people ride together in a single vehicle instead of each driving alone in their own individual vehicle. A carpooling system may automatically match users into a shared ride based on various parameters specified by the users. However, in certain circumstances, it may be impractical for a user to specify/update all parameters prior to scheduling a ride. Conventional carpooling systems do not have an efficient mechanism to collect user feedback about the missing/stale parameters.

### BRIEF DESCRIPTION OF THE DRAWINGS

FIG. 1 is a simplified block diagram of an automated ride scheduling system according to an embodiment.

FIG. 2 is a simplified block diagram of a user device according to an embodiment.

FIG. 3 illustrates an exemplary message to solicit feedback from a user according to an embodiment.

FIG. 4 illustrates an exemplary message to solicit feedback from a user according to an embodiment.

FIG. 5 illustrates a system to generate feedback messages according to an embodiment.

### DETAILED DESCRIPTION

Embodiments may be discussed in systems to efficiently solicit feedback from ride sharing system users. In an embodiment, a message may be sent to a user to solicit user feedback about a shared ride parameter. The message may include a question based on a value of the parameter. A response to the message may be received from the user. A setting of the ride sharing system may be modified based on the response. In an embodiment, the modified setting may be a shared ride parameter value associated with the user. In an embodiment, the modified setting may be a tolerance level of a shared ride parameter associated with the user. In an embodiment, the modified setting may be a shared ride parameter value associated with a plurality of users. In an embodiment, the message may be sent as an e-mail, a text message, a web page, and/or a chat message. In an embodiment, the message may be automatically generated based on data collected by a computer of a vehicle used for the shared ride.

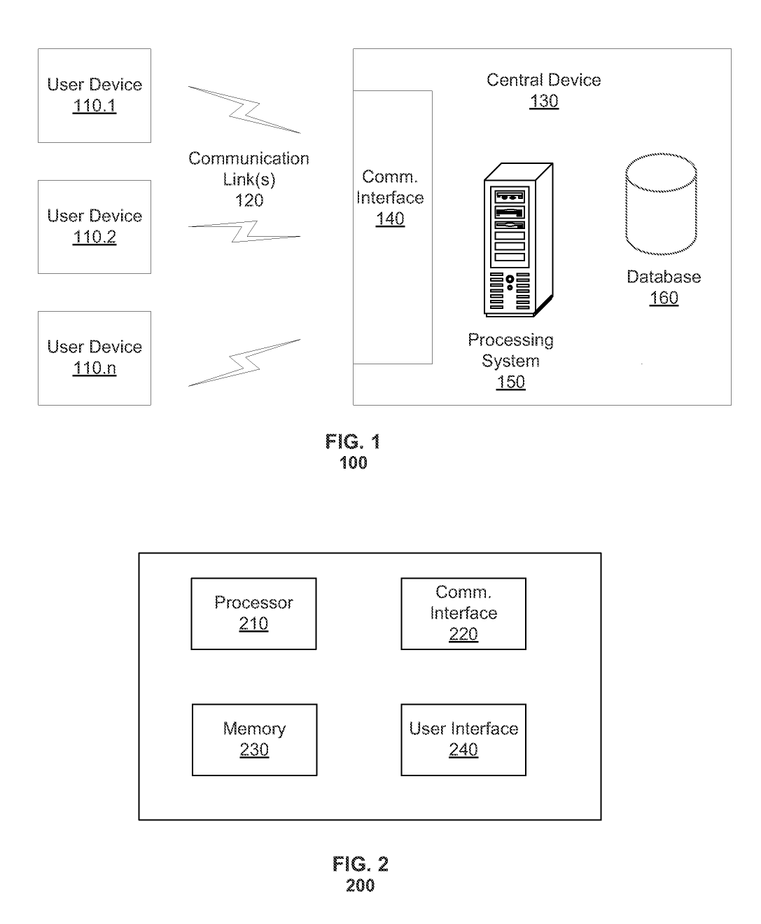

FIG. 1 illustrates a simplified block diagram of an automated ride scheduling system 100 according to an embodiment of the present invention. The system 100 may include a plurality of user devices 110.1-110.n that are communicatively coupled via communication link(s) 120 to a central device 130. The communication link(s) 120 may be provided as a computer network or a wireless network such as a cellular network, WLAN network, short range communication network (i.e. BLUETOOTH®) or a combination of different wired and/or wireless networks. For example, the user device 110.1 may initially communicate with a cellular network then thru an IP network to access the central device 130.

The central device 130 may include a communication interface 140, a processing system 150, and a database 160. The communication interface 140 may be compatible with various networks provided by the communication link(s) 120. The processing system 150 may execute a ride sharing application stored thereon. Information associated with the application may be stored in the database 160. The database 160 may be provided as a single database or a combination of multiple databases.

FIG. 2 illustrates a simplified block diagram of a user device 200 according to an embodiment of the present invention. The user device 200 may include a processor 210, a communication interface 210, a memory 230, and a user interface 240. The user device 200 may be provided as a desktop computer, laptop, tablet, pda, cellular phone, vehicle navigation system, or other suitable devices.

The processor 210 may control the operations of the user device 200. The processor 210 may be any of a plurality of conventional processing systems, including microprocessors, digital signal processors, and field programmable logic arrays.

The communications interface 210 may allow the user device to communicate with the central device. The communications interface may be a wireless internet interface, a wired internet interface, cellular network interface, Bluetooth interface, or any suitable communication protocol interface.

The memory 230 may store program instructions as well as other data, for example, ride sharing application data. Memory 230 may include any combination of conventional memory circuits, including, electrical, magnetic, or optical memory systems. For example, memory 230 may include read only memories, random access memories, and bulk storage.

The user interface 240 may include a display screen and input device. The display screen may be, for example, an LCD screen, a CRT, a plasma screen, an LED screen or the like. The input device may be a keyboard, a mouse, touch screen sensors or any other user input device that would allow a user to interact with the user device 200.

A ride sharing application user may specify a set of ride sharing parameters to automatically schedule a ride with one or more other users. The user may specify the parameters through any type of interface on a user device including a web interface, a mobile interface, and/or a stand-alone application interface. The parameters may include values representing a start location, end location, traveling time, role, detour time, vehicle information such as vehicle make, model, preferences such as social compatibility preferences (e.g., gender, age, occupation) and vehicle preferences (e.g., type of music played in the vehicle, temperature within the vehicle, size of the vehicle). The role may represent whether the user prefers to be a driver or a passenger. The detour time may represent the time the user is willing to prolong his ride in order to pick up and drop off passengers. The set of parameters specified by a user for a ride may be referred to as the user's ride intent.

The parameters associated with a user may be specified at the point in time when a ride is requested and/or the parameters may be stored in a user profile prior to a ride request. For example, the user may specify the start location and end location each time the user requests a ride. However, the user may save his vehicle's make and model in a user profile so that he does not have to enter the same information redundantly when requesting a ride.

The ride sharing application may receive the user's ride intent and may compare it with ride intents entered by other users. The ride sharing application may then schedule a shared ride between a set of users with matching ride intents. If a threshold number of parameters in a first user's ride intent and a second user's ride intent match, the ride sharing application may determine that the two ride intents match. The ride sharing application may determine that there is match between a parameter of a first user and a corresponding parameter of a second user as long as the values of the parameters are within a tolerance level. For example, the application may determine that there is match between a start location of A and start location of B as long as location A and location B are within a particular distance from each other. Similarly, the application may determine that there is match between a vehicle music preference of “classical pop music” and a vehicle music preference of “contemporary pop music” since both match on the pop music aspect. The tolerance level may vary depending on the user and/or the parameter.

In certain circumstances, it may be impractical for a user to specify all parameters and/or respective tolerance levels in a ride sharing application prior to scheduling a ride. For example, it may be tedious for a user to enter all of his music preferences and/or music tolerances in a user profile or a ride request. Furthermore, the parameter values and/or parameter tolerance levels associated with a user may change. For example, a user may prefer to listen to “pop music” during the summer season and may prefer to listen to “classical music” during the winter. However, the user may find it impractical to update his ride sharing preferences constantly.

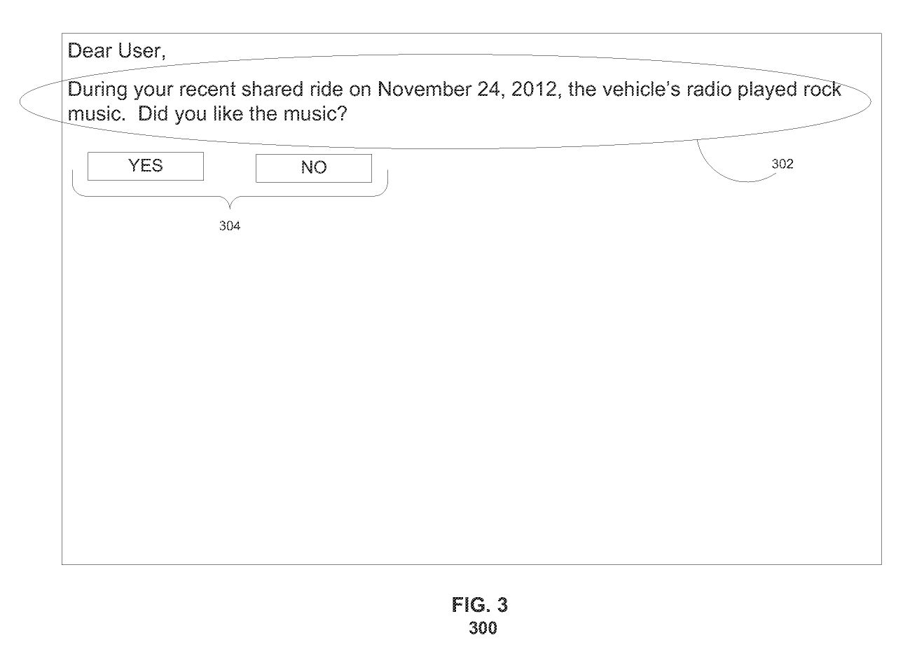

To address the above problems, in an embodiment, the user may provide feedback about various aspects of a shared ride after the ride is completed or while the shared ride is in progress. In an embodiment, the feedback may be used to update the parameters associated with the user so that future shared rides may be scheduled based on the updated parameters. FIG. 3 illustrates an exemplary message 300 to solicit feedback from the user according to an embodiment. The message may include one or more questions 302 about one or more parameters of a shared ride. The message may include a mechanism 304 to provide feedback about the one or more parameters. For example, the message 300 may inform the user that during her previous shared ride, a particular type of music such as “rock” music was played on the vehicle's radio, and may request feedback on whether the user liked the music 302. The message 300 may also present the user with “yes” and “no” visual buttons 304 which the user may click on to convey her feedback.

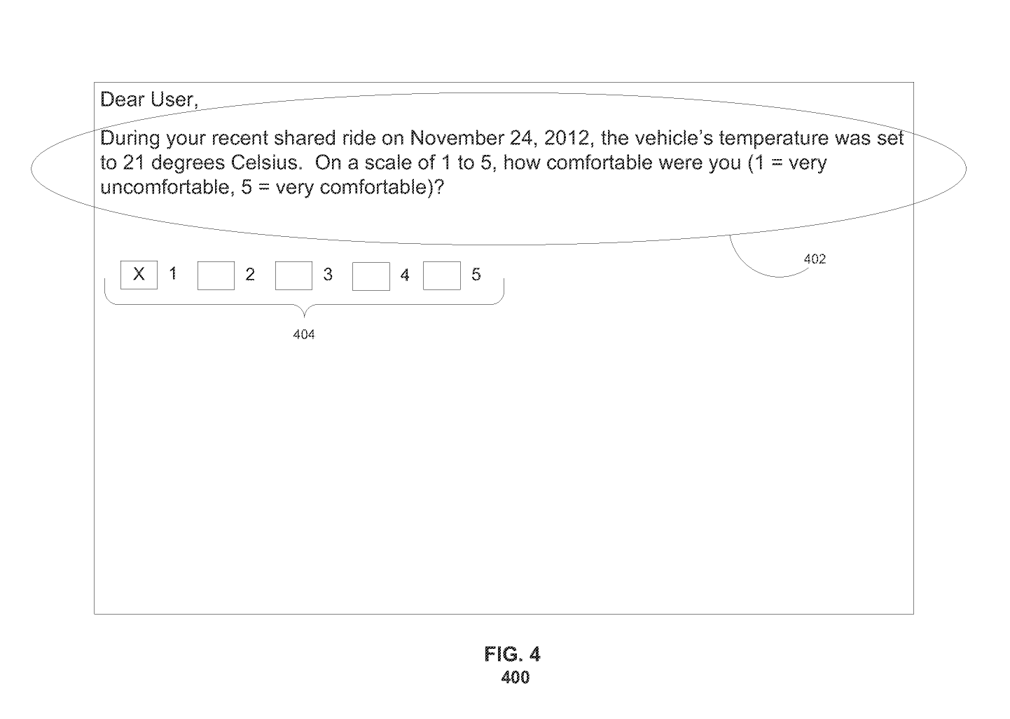

FIG. 4 illustrates another exemplary message 400 to solicit feedback from the user according to an embodiment. The message 400 may include one or more questions 402 about one or more parameters of a shared ride. The message may include a mechanism 404 to provide feedback about the one or more parameters. For example, the message 400 may inform the user that during her previous shared ride, the temperature inside the car was set at a particular temperature such as 21 degrees Celsius, and may request user feedback on temperature preference 402. The message 400 may also present the user with a satisfaction scale 404 which the user may click to convey her feedback.

The exemplary messages to solicit feedback 300 and 400 are illustrative and are not intended to restrict the scope of the invention. The message soliciting feedback may be delivered to the user in any electronic format including e-mail, text message (such as text messages sent using a Short Message Service (SMS) and/or Multimedia Messaging Service (MMS)), web page, and an application specific format such as a Skype®, Google® chat, and WhatsApp® message. Similarly, the mechanism to provide feedback may be implemented in many ways depending on the message format including buttons, radio buttons, check boxes, text boxes, and/or drop down menus. In an embodiment, the mechanism to provide feedback may not be part of the message. For example, in response to a text message, a user may press one or more physical buttons on a user device to provide feedback.

In an embodiment, feedback from the user may be sent to the ride sharing system. Responsive to the feedback from the user, the ride sharing system may adjust one or more parameters associated with the user. For example, a first user may not have entered any music preferences prior to scheduling a shared ride. Therefore, the ride sharing system may have matched the first user with a second user having a “rock” music preference. Consequently, during the shared ride, “rock” music may have been played in the vehicle. A message such as message 300 may be sent to the first user to receive his feedback regarding the music. The first user may not have enjoyed the music played and therefore, may provide feedback indicating that he did not like the music. In response to the user's feedback, the ride sharing system may modify the parameter(s) associated with the first user to indicate that in the future, the first user may not be matched with other users preferring “rock” music.

In an embodiment, responsive to the feedback from the user, the ride sharing system may adjust the tolerance level of one or more parameters associated with the user. For example, a first user may have indicated in her user profile that she prefers to listen to “pop” music during shared rides. The first user may not have indicated any preference towards “rock” music. Therefore, the ride sharing system may have matched the first user with a second user having a “rock” music preference. Consequently, during the shared ride, “rock” music may have been played in the vehicle. A message such as message 300 may be sent to the first user to receive her feedback regarding the music. The first user may have enjoyed the music played and therefore, may provide feedback indicating that she liked the music. In response to the user's feedback, the ride sharing system may modify the parameter(s) associated with the first user to indicate that in the future, the first user may be matched with other users preferring “rock” music.

In an embodiment, responsive to the feedback from one or more users, the ride sharing system may adjust the parameters and/or tolerance level of multiple users of the ride sharing system. For example, after multiple shared rides are completed, messages such as message 400 may be sent to a set of users to receive their feedback regarding the preferred temperature during the shared rides. A majority of the feedback may indicate that the preferred temperature inside a vehicle is 21 degrees Celsius. In response to the users' feedback, the ride sharing system may set the default temperature preference to 21 degrees Celsius for all users who do not specify a particular temperature preference in their user profiles and/or shared ride requests.

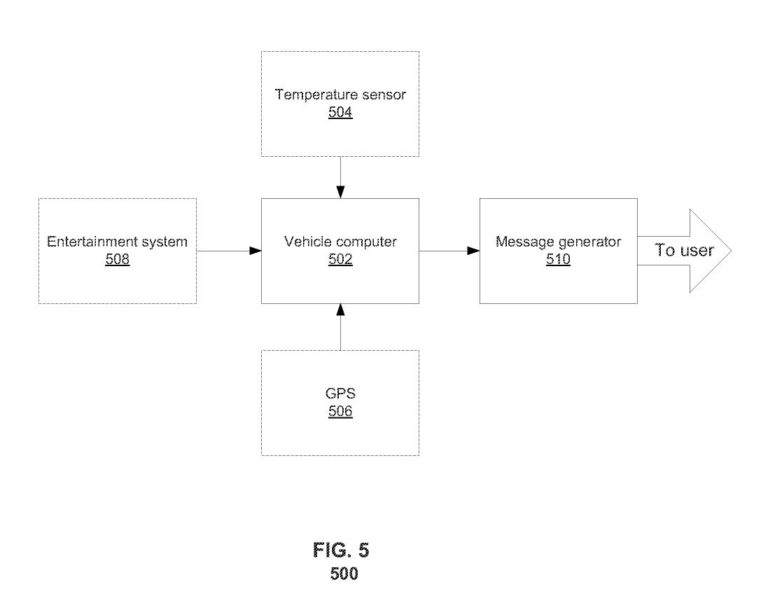

In an embodiment, the message to solicit feedback may be automatically generated in response to information received and/or processed by one or more sensors and/or computers in a vehicle used for a shared ride. FIG. 5 illustrates a system 500 to generate feedback messages according to an embodiment. A vehicle computer 502 such as the computer which manages various functions of the vehicle including temperature, entertainment (e.g., music and video), and global positioning system (GPS) may send ride information to a message generator 510. The message generator 510 may generate a message based on the information and send the message to a user.

In an embodiment, the vehicle's computer 502 may receive data indicating that the vehicle is being used for a shared ride. For example, the vehicle's computer may be connected to a ride sharing system database and may determine that the vehicle is currently within a shared ride time window. In an embodiment, during a shared ride, the vehicle's computer 502 may collect data from other components of the vehicle such as a temperature sensor 504 which tracks the temperature inside the vehicle, an entertainment system 508 which tracks the audio/video played in the vehicle, and a GPS device 506 which tracks the route, speed, etc. The vehicle's computer 502 may transmit the collected data to the message generator 510. In an embodiment, the message generator 510 may compare the collected data and determine whether a message should be sent to a user to solicit feedback. For example, the message generator may be connected to the ride sharing system database and may check whether a user in the shared ride has stored her music preferences in ride sharing system. If the user has not stored her music preferences, the message generator 510 may generate a message asking the user whether she enjoyed the music played during the shared ride.

In an embodiment, one or more devices not connected to the vehicle (not shown) may send shared ride data to the message generator 510. For example, a user's smartphone with a temperature sensor may track the temperature inside the vehicle and the smartphone may send this data to the message generator 510. An application executed within the smartphone may track the audio/video played in the vehicle and the smartphone may send this data to the message generator 510. Similarly, GPS functionality in the smartphone may track the route, speed, etc. and the smartphone may send this data to the message generator 510. A person having ordinary skill in the art will appreciate that any device with access to information pertaining to the shared ride may send data to the message generator 510. The smartphone is an example of such a device. In an embodiment, the message generator 510 may be integrated into the device.

A person having ordinary skill in the art will appreciate that the vehicle components shown in FIG. 5: the temperature sensor 504, the entertainment system 508, and the GPS device 506 are illustrative and are not intended to restrict the invention. Any components in the vehicle may communicate with the vehicle's computer 502.

Although FIG. 5 illustrates the vehicle's computer 502 and message generator 510 as separate components, in other embodiments, the message generator 510 may be a part of the vehicle's computer 502. Similarly, some of the functionality of the vehicle's computer 502 may be incorporated into the message generator 510. For example, in an embodiment, the vehicle's computer 502 may not be connected to the ride sharing system's database. Therefore, the vehicle's computer may send all collected vehicle data to the message generator 510 without any filtering. The message generator 510 may then determine whether the data is associated with a shared ride.

The foregoing description has been presented for purposes of illustration and description. It is not exhaustive and does not limit embodiments of the invention to the precise forms disclosed. Modifications and variations are possible in light of the above teachings or may be acquired from the practicing embodiments consistent with the invention. For example, some of the described embodiments may include software and hardware, but some systems and methods consistent with the present invention may be implemented in software or hardware alone. Additionally, although aspects of the present invention are described as being stored in memory, this may include other computer readable media, such as secondary storage devices, for example, solid state drives, or DVD ROM; the Internet or other propagation medium; or other forms of RAM or ROM.

We claim:

1. A processor-implemented method comprising:
sending a message to a user to solicit user feedback about a shared ride parameter, wherein the message includes a question based on a value of the parameter and the message is sent as at least one of an e-mail, a text message, a web page, and a chat message;
receiving a response to the message from the user; and
modifying a setting of a ride sharing system based on the response, wherein the modified setting is a shared ride parameter value associated with the user.

2. A processor-implemented method comprising:
sending a message to a user to solicit user feedback about a shared ride parameter, wherein the message includes a question based on a value of the parameter;
receiving a response to the message from the user; and
modifying a setting of a ride sharing system based on the response.

3. The method of claim 2, wherein the modified setting is a shared ride parameter value associated with the user.

4. The method of claim 2, wherein the modified setting is a tolerance level of a shared ride parameter associated with the user.

5. The method of claim 2, wherein the modified setting is a shared ride parameter value associated with a plurality of users.

6. The method of claim 2, wherein the message is sent as at least one of an e-mail, a text message, a web page, and a chat message.

7. The method of claim 2, wherein the message is automatically generated based on data collected by a computer of a vehicle used for the shared ride.

8. The method of claim 2, wherein the message is automatically generated based on data collected by a device not connected to a vehicle used for the shared ride.

9. An apparatus comprising:
a processor to:
receive, from a user, a response to a message sent to the user to solicit user feedback about a shared ride parameter, wherein the message includes a question based on a value of the parameter; and
modify a setting of a ride sharing system based on the response.

10. The apparatus of claim 9, wherein the modified setting is a shared ride parameter value associated with the user.

11. The apparatus of claim 9, wherein the modified setting is a tolerance level of a shared ride parameter associated with the user.

12. The apparatus of claim 9, wherein the modified setting is a shared ride parameter value associated with a plurality of users.

13. The apparatus of claim 9, wherein the message is sent as at least one of an e-mail, a text message, a web page, and a chat message.

14. The apparatus of claim 9, wherein the message is automatically generated based on data collected by a computer of a vehicle used for the shared ride.

15. A non-transitory computer-readable medium embodied with computer-executable instructions for causing a computer to execute instructions, the computer instructions comprising:
sending a message to a user to solicit user feedback about a shared ride parameter, wherein the message includes a question based on a value of the parameter;
receiving a response to the message from the user; and
modifying a setting of a ride sharing system based on the response.

16. The medium of claim 15, wherein the modified setting is a shared ride parameter value associated with the user.

17. The medium of claim 15, wherein the modified setting is a tolerance level of a shared ride parameter associated with the user.

18. The medium of claim 15, wherein the modified setting is a shared ride parameter value associated with a plurality of users.

19. The medium of claim 15, wherein the message is sent as at least one of an e-mail, a text message, a web page, and a chat message.

20. The medium of claim 15, wherein the message is automatically generated based on data collected by a computer of a vehicle used for the shared ride.
